(19) United States
(12) Patent Application Publication
(10) Pub. No.: US 2007/0266628 A1
(43) Pub. Date: Nov. 22, 2007

(54) System and method for injecting trees

(76) Inventor: Glayne D. Doolittle, Omaha, NE (US)

Correspondence Address: THOMTE LAW OFFICE, L.L.C., 2120 S. 72ND STREET, SUITE 1111, OMAHA, NE, 68124, US

(21) Appl. No.: 11/522,256

(22) Filed: Sep. 15, 2006

Related U.S. Application Data
(63) Continuation-in-part of application No. 11/238,783, filed on Sep. 29, 2005, now Pat. No. 7,178,286.

(51) Int. Cl. A01G 29/00

(52) U.S. Cl. 47/57.5

(57) ABSTRACT

A system and method for injecting liquids into trees is provided with an injection device having a liquid container and a removable needle. The system positions the needle into the sapwood of the tree. Liquid is injected into the tree through ejector holes in the needle. The ejector holes may be sized to prevent the liquid from reentering the needle once the ejector holes engage tree material. A check valve may be associated with the needle to substantially prevent the liquid from exiting the tree through the needle. The needle may be permanently left in place or removed after the liquid disburses into the tree.

### CROSS-REFERENCE TO RELATED APPLICATION

This is a continuation-in-part application of Petitioner's earlier application Ser. No. 11/238,783 filed Sep. 29, 2005, entitled SYSTEM AND METHOD FOR INJECTING TREES.

### BACKGROUND

Prior art methods of tree injection typically involve a two-step operation, which include cutting an opening in the tree with one device and then injecting the tree with a second device. Such a two-step process is time consuming and involves considerable manual effort. Moreover, as the operation involves two steps, there is a delay between making the cut in the tree and introducing of the chemical to the cut, which is critical as trees have the ability to quickly heal incisions, protecting them from entry of bacteria or other such harmful organisms. The openings further allow for the entry of air into the tree. The air quickly expands inside the negative pressure of the sap, which typically disrupts the flow of sap in the area, preventing the thorough disbursal of injected chemicals. Furthermore, the air may introduce one or more types of harmful airborne fungi and bacteria.

Examples of prior art injection systems are found in Mauget, U.S. Pat. No. 3,304,655, and Barber, U.S. Pat. No. 2,116,591, which both disclose injection systems having a needle. However, the problem encountered in utilizing both examples of the prior art is that, before the needle may be inserted into a tree, a hole must be formed in the tree to prevent the needle from becoming plugged by tree fiber when it is inserted into the tree. Generally, at least a ⅛″ hole needs to be drilled in the tree to insert the needles of the above inventions, which causes a great deal of damage to a tree. Moreover, both of these prior art examples require the aforementioned two-step operation to achieve injection of a tree.

Other prior art injection methods require the use of implants at the injection site to facilitate the use of an injection device or to retain the injected chemicals within the tree. However, such implants are provided with large diameters that disrupt the flow of water and nutrients in the tree. Some implants are too large to allow the tree to sufficiently heal the area injured by the implant. Moreover, the size of such implants, combined with the hardened nature of the materials from which they are formed, may result in serious bodily injury to personnel who may need to later cut the tree down, due to disease, damage to the tree, or an emergency situation, such as a fire.

Accordingly, what is needed is a new system and method for injecting materials into trees that is relatively quick and efficient, while reducing the damage and disruption suffered by the tree. Moreover, such a system and method should not pose a risk of serious harm to personnel who must cut the tree down.

### SUMMARY OF THE INVENTION

This Summary is provided to introduce a selection of concepts in a simplified form that are further described below in the Detailed Description. This Summary is not intended to identify key features or essential features of the claimed subject matter. Moreover, this Summary is not intended for use as an aid in determining the scope of the claimed subject matter.

A system and method of the present invention is provided for injecting materials into trees. The system is generally provided with an injection device, having forward and rearward end portions, an elongated needle that is removably coupled with the forward end portion, and a container for holding a liquid. The needle is provided with an open rearward end portion that is in communication with an open inner chamber and at least one ejector hole, which is formed in a side wall of the needle, adjacent a forward end portion of the needle. The needle is coupled with the injection device in a manner that permits the liquid to be selectively transferred from the container, through said needle, and out the one or more ejector holes. In one preferred embodiment the needle is provided in a small gauge and the one or more ejector holes are large enough to permit the passage of injectable liquids but small enough to self-seal when contacted by tree material. Another preferred embodiment associates a check valve with the needle that substantially prevents the flow of fluids from the tree through the needle.

The injection device is engaged with the tree trunk in a manner that injects the needle into the tree trunk so that the one or more ejector holes are positioned in contact with tree material, such as tree fiber and/or sap, located interiorly of the tree's outer bark layer and exteriorly of the heartwood portion of the tree. The liquid is injected into the tree trunk so that liquid is transferred from the container, through the injection device, through the needle, and out the one or more ejector holes. The injection device is then disengaged with the tree trunk and the needle so that the needle is at least temporarily left within the tree trunk.

It is therefore a principal object of the present invention to provide an improved system and method for injecting trees.

A further object of the present invention is to provide an improved tree injection method that will cause relatively little damage to a tree.

Still another object of the present invention is to provide a tree injection method that incorporates the use of expendable injection needles that are left within a tree after fluids are injected into the tree.

Yet another object of the present invention is to provide a tree injection method that utilizes an injection needle having one or more ejector holes that are self-sealing when they come into contact with tree material.

A further object of the present invention is to provide a tree injection method that utilizes an injection needle having a check valve that, when used to inject liquid into a tree, substantially prevents the passage of the liquid out the tree through the injection needle.

Still another object of the present invention is to provide a tree injection method that does not require preparation of a tree with a cut or a hole prior to injecting the tree.

Yet another object of the present invention is to provide a system and method for tree injection that are relatively simple and inexpensive to manufacture and implement.

A further object of the present invention is to provide a tree injection method that is both time and cost efficient.

These and other objects of the present invention will be apparent to those having skill in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of one preferred embodiment of the tree injection system of the present invention and one preferred manner in which it may be used;

FIG. 2 is an isometric view of one preferred embodiment of an injection needle of the present invention;

FIG. 3 is a partial, cut-away view of a tree trunk having injection needles of the present invention disposed therein;

FIG. 4 is a partial, cut-away view of a tree trunk and further depicts one preferred embodiment of the tree injection system of the present invention and one manner in which it could be used to inject a liquid into a tree trunk and substantially retain said liquid within the tree trunk;

FIG. 5 depicts another preferred embodiment of the tree injection needle of the present invention and one manner in which it could be used to inject a liquid into a tree trunk and substantially retain said liquid within the tree trunk; and

FIG. 6 depicts yet another preferred embodiment of the tree injection needle of the present invention and one manner in which it could be used to inject a liquid into a tree trunk and substantially retain said liquid within the tree trunk.

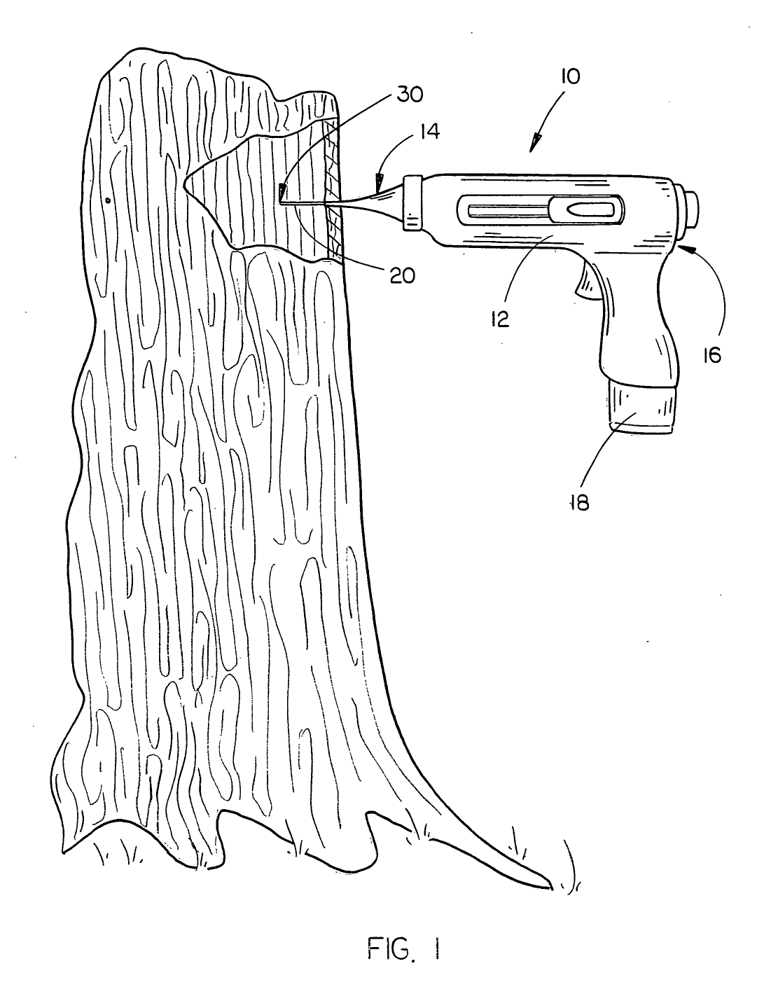

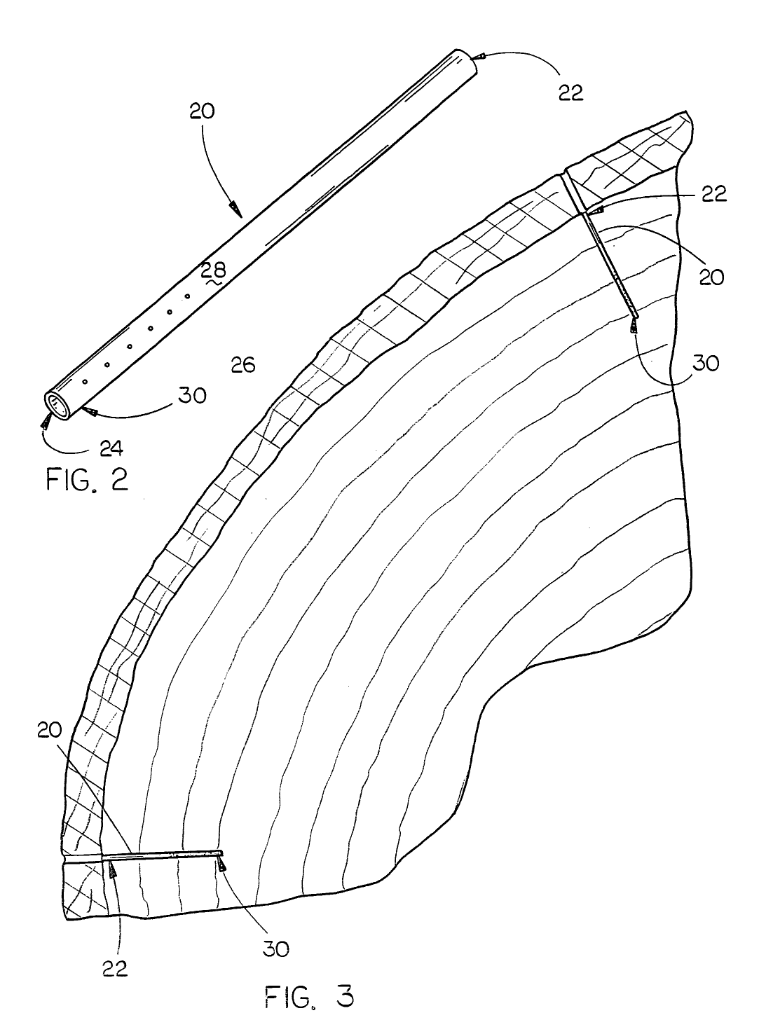

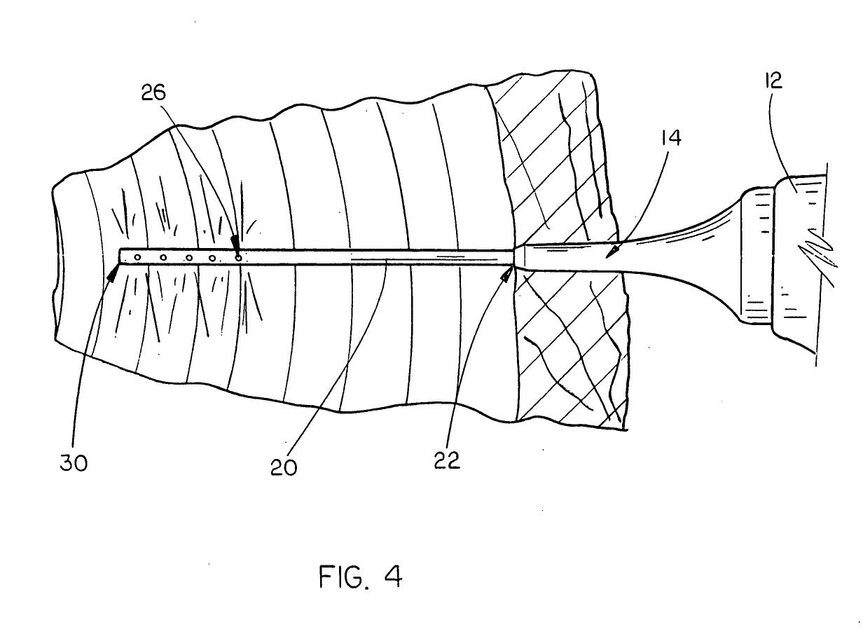

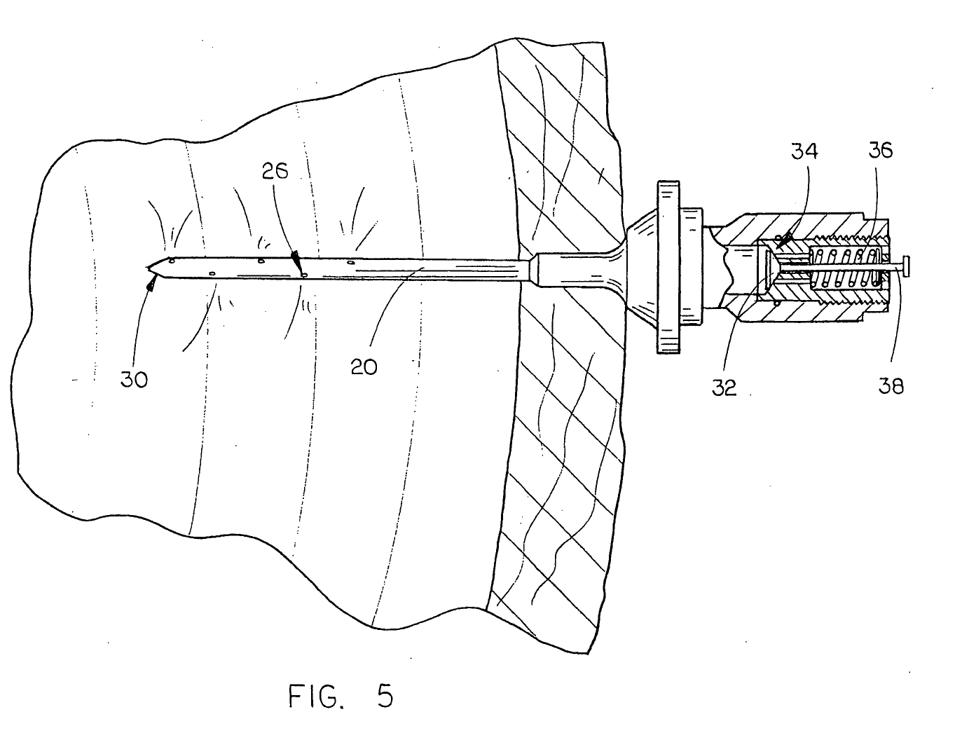

### DETAILED DESCRIPTION

Embodiments are described more fully below with reference to the accompanying drawings, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The injection system 10 of the present invention is generally provided with an injection device 12, having a forward end portion 14 and a rearward end portion 16. A container 18 or attachment made via hose to a container, should be provided for holding an injectable liquid. The container 18 should be operatively coupled with the injection device 12 so that the liquid disposed within the container 18 may be selectively dispensed through the injection device 12. An elongated needle 20, having an open rearward end portion 22, is operatively coupled with the forward end portion 14 of the injection device 12 so that the rearward end portion 22 is placed in open communication with the injection device 12 and the container 18. The needle 20 is further provided with an open inner chamber 24 that is in open communication with the rearward end portion 22 and at least one ejector hole 26 which is formed in a sidewall 28 of the needle 20, adjacent a forward end portion 30 thereof. Accordingly, fluid is permitted to be selectively transferred in a first flow direction from the injection device 12 through the needle 20 and out the at least one ejector hole 26.

In use, the injection system 10 is assembled and an injectable liquid is provided within the container 18. An elongated needle 20 is then removably coupled to the forward end portion 14 of the injection device 12. Injection system 10 is then placed closely adjacent the trunk of a tree having an outer bark layer that covers inner wood layers including an inner bark layer, a cambium layer, a sapwood layer and a heartwood portion. The forward end portion 30 of the needle 20 is placed against the outer bark layer of the tree. Injection system 10 may then be pushed forward, disposing the needle 20 at least partially within the tree trunk. Preferably, the needle 20 is inserted into the tree trunk so that the injector holes 26 are located interiorly of the outer bark layer and exteriorly of the heartwood portion of the tree trunk.

With the injection system 10 properly in place, the individual may then inject the liquid into the tree trunk so that the liquid is transferred from the container 18 through the injection device 12, through the needle 20 and out one or more of the ejector holes 26. Means should be associated with the needle 20 that substantially prevents the liquid from flowing in an opposite, second flow direction out the needle 20 once the liquid is transferred out the ejector holes 26 into the tree. In one preferred embodiment, the one or more ejector holes 26 are shaped and sized to be self-sealing during an injection process. Specifically, the ejector holes 26 should be sized and shaped to permit the passage of the injectable liquid while being too small to allow the passage of tree material, such as tree fiber, therethrough. Experimentation with various diameters of ejector holes 26 has demonstrated that ejector holes having a diameter greater than approximately 0.02 inches permits the passage of injectable liquids but are not self sealing. In such an instance, the tree sap and injectable liquid will pass the ejector holes 26, into the open inner chamber 24 and out the open rearward end portion 22 of the needle 20. To the ability of the tree to expel foreign material, it is possible that substantial quantities of the injected liquid may be expelled from the tree along with tree sap. However, ejector holes 26 provided with a diameter of approximately 0.02 inches and smaller allowed the passage of injectable liquids but not tree sap. Accordingly, as the injectable liquid is disbursed into the tree trunk, natural tree material such as tree fiber and oftentimes sap comes into contact with the injector holes 26 and effectively seals the injector holes 26, substantially prevented the passage of tree sap or the injectable liquid into the open inner chamber 24 and out the open rearward end portion 22 of the needle 20.

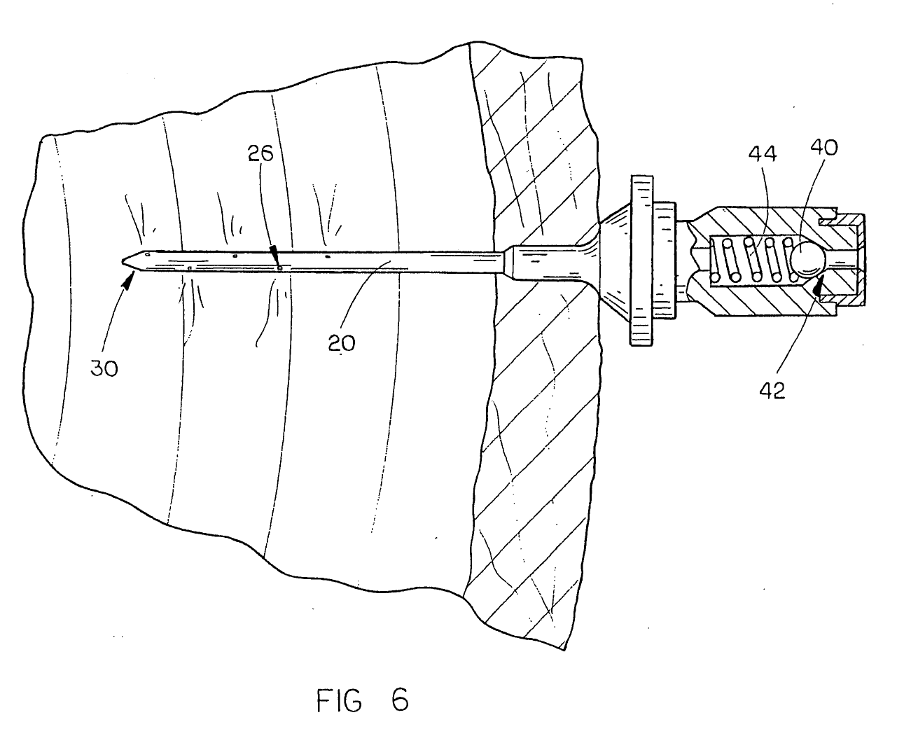

In another preferred embodiment, the means for preventing the liquid from flowing in an opposite, second flow direction out the needle 20 is comprised of a check valve that is associated with the needle 20. It is contemplated that several different forms of check valves may be used. In one example, depicted in FIG. 5, the check valve is comprised of a valve 32, a seat 34 and a spring 36. The spring 36 is positioned to bias the valve 32 in a closed position (depicted) against the seat 34 and yield in response to liquid being transferred by the injection device 12 in the first flow direction through needle 20. The check valve may also be provided with a stem 38 that extends outwardly from the check valve, in a rearward direction, when the valve 32 is in the closed position. This provides a user with the ability to push the stem 38 in a forward direction to move the valve 32 into its open position and detect whether or not fluid is flowing in the second flow direction. It will be advisable to leave the needle 20 in its injection position when such fluid flow is detected. However, where minimal flow is detected, the needle may be removed from the tree without significant concern that the liquid will escape from the tree. In another example, depicted in FIG. 6, the check valve may simply be comprised of a ball-shaped stop 40 that is movable between a closed position adjacent a seat 42 at the rearward portion of the check valve and an open position toward a forward portion of said check valve. A spring 44 may be used to bias the ball-shaped stop 40 toward the seat 42 but yield in response to liquid being transferred by the injection device 12 in the first flow direction through needle 20. When desirable, the means may be comprised of one or more ejector holes 26, having a diameter greater than approximately 0.02 inches, and a check valve.

It is contemplated that the needle 20 may be disposed at various depths within the tree to attain a successful injection. However, it will be preferred that the needle 20 be inserted into the tree trunk so that at least one or more ejector holes 26 is located within the sapwood layer of the tree trunk, which will facilitate an adequate dispersal of the injectable liquid throughout the tree. Once the liquid has been injected into the tree, the user may simply disengage the injection device 12 with the tree trunk and the needle 20 so that the needle 20 is at least temporarily left within the tree trunk. It is contemplated that the needle 20 could be left within the tree trunk indefinitely. Constructing the needle 20 of stainless steel or a sufficiently rigid polymer will limit the disruption or contamination of the injected tree. Moreover, forming the needles 20 so that they are roughly 14 gauge in size or smaller will allow the needles 20 to be successfully inserted into most trees without bending or fracturing the needles 20. Moreover, 14 gauge and smaller needles left within a tree will pose little, if any, risk to cutting implements, such as a chainsaw, used to later cut the tree down for any reason. However, it is contemplated that an individual injecting the tree could simply wait a small amount of time, such as a half an hour, and remove the needle 20 entirely. The amount of time required to leave the needle in place will depend upon the time of the year and the type of tree being injected. Some trees, at various times of the year, may require longer periods of time in order to disperse the injected fluid to permit removal of the needle 20.

Although the invention has been described in language that is specific to structural features and/or methodological steps, it is to be understood that the invention defined in the appended claims is not necessarily limited to the specific features or steps described. Rather, the specific features and steps are described as forms of implementing the claimed invention. Since many embodiments of the invention can be made without departing from the spirit and scope of the invention, the invention resides in the claims hereinafter appended.

What is claimed is:

1. A method for injecting liquids directly into the trunk of a tree having an outer bark layer that covers inner wood layers including an inner bark layer, a cambium layer, a sapwood layer and a heartwood portion, the method comprising:
providing an injection device, having forward and rearward end portions, an elongated needle extending from said forward end portion, and a container for holding a liquid; said needle having an open rearward end portion that is in communication with an open inner chamber and at least one ejector hole, which is formed in a forward end portion of said needle; said needle being operatively coupled with said injection device such that said liquid may be transferred in a first flow direction from said device through said needle and out said at least one ejector hole; said needle having means for substantially preventing said liquid from flowing in an opposite, second flow direction out said needle once said liquid is transferred out said at least one ejector hole into a tree;
inserting said needle into the tree trunk to an injection position, which places said at least one ejector hole in contact with tree material located interiorly of the outer bark layer and exteriorly of the heartwood portion of the tree trunk;
injecting said liquid into the tree trunk so that liquid is transferred from said container, through said injection device, through said needle and out said at least one ejector hole; and
disengaging said injection device with the tree trunk and said needle so that said needle is at least temporarily left in said injection position within the tree trunk.

2. The method of claim 1 wherein said means is comprised of at least one ejector hole having a size that is no greater than approximately 0.02 inches in diameter.

3. The method of claim 2 wherein said means is comprised of a plurality of ejector holes, sized no greater than approximately 0.02 inches in diameter, that are formed in the side wall of said needle adjacent the forward end portion of said needle.

4. The method of claim 1 wherein said means is comprised of a check valve associated with said needle.

5. The method of claim 4 wherein said check valve is operatively coupled with the rearward end portion of said needle.

6. The method of claim 4 wherein said check valve is a ball-shaped stop that is movable between a closed position adjacent a seat at the rearward portion of said check valve and an open position toward a forward portion of said check valve;

7. The method of claim 6 wherein said check valve is further comprised of a spring that is positioned to bias said ball-shaped stop toward said seat but yield in response to liquid being transferred by said injection device in the first flow direction through said needle.

8. The method of claim 4 wherein said check valve is comprised of a valve, a seat and a spring positioned to bias said valve in a closed position against said seat and yield in response to said liquid being transferred in said first flow direction through said needle.

9. The method of claim 8 further comprising:
providing said check valve with a stem that extends outwardly from said check valve, in a rearward direction, when said valve is in said closed position;
pushing said stem in a forward direction to move said valve into its open position; and
detecting whether or not fluid flow in said second flow direction is present.

10. The method of claim 9 further comprising;
removing said needle from the tree trunk if no more than minimal fluid flow in said second flow direction is detected.

11. The method of claim 1 further comprising:
leaving said needle within the tree trunk indefinitely.

12. The method of claim 4 wherein said means is further comprised of a plurality of ejector holes, sized no greater than approximately 0.02 inches in diameter, that are formed in the side wall of said needle adjacent the forward end portion of said needle.

13. The method of claim 12 wherein said check valve is comprised of a valve, a seat and a spring positioned to bias said valve in a closed position against said seat and yield in response to said liquid being transferred in said first flow direction through said needle.

14. The method of claim 13 further comprising:
providing said check valve with a stem that extends outwardly from said check valve, in a rearward direction, when said valve is in said closed position;
pushing said stem in a forward direction to move said valve into its open position; and
detecting whether or not fluid flow in said second flow direction is present.

15. The method of claim 14 further comprising;
removing said needle from the tree trunk if no more than minimal fluid flow in said second flow direction is detected.

16. The method of claim 1 wherein the tree is not prepared with an opening prior to positioning said needle within the tree.
